(19) United States
(12) Patent Application Publication
(10) Pub. No.: US 2008/0148026 A1
(43) Pub. Date: Jun. 19, 2008

(54) Checkpoint Efficiency Using a Confidence Indicator

(76) Inventors: Ashutosh S. Dhodapkar, Fremont, CA (US); Michael G. Butler, San Jose, CA (US)

Correspondence Address: Lawrence J. Merkel;Meyertons, Hood, Kivlin, Kowert & Goetzel, P.C., P.O. Box 398, Austin, TX, 78767-0398, US

(21) Appl. No.: 11/611,626

(22) Filed: Dec. 15, 2006

(51) Int. Cl. G06F 9/30

(52) U.S. Cl. 712/228; 712/E09.016

(57) ABSTRACT

In one embodiment, a processor comprises a predictor, a checkpoint unit, and circuitry coupled to the checkpoint unit. The predictor is configured to predict an event that can occur during an execution of an instruction operation in the processor. Furthermore, the predictor is configured to provide a confidence indicator corresponding to the prediction. The confidence indicator indicates a relative probability of a correctness of the prediction. The checkpoint unit is configured to store checkpoints of speculative state corresponding to respective instruction operations. Coupled to receive the confidence indicator, the circuitry is configured to save a first checkpoint of speculative state corresponding to the instruction operation if the confidence indicator indicates a first level of probability of correctness. The circuitry is further configured not to save the first checkpoint if the confidence indicator indicates a second level of probability.

### BACKGROUND

1. Field of the Invention

This invention is related to the field of processors and, more specifically, to checkpointing speculative state in a processor.

2. Description of the Related Art

Processors often implement speculative execution as one technique to reach performance goals. Generally, speculative execution of instructions includes at least partially processing instructions, including generating speculative results, before they are known to be executed via the completion of preceding instructions in the program order. Speculative execution may include executing instructions that are subsequent to one or more predicted branch instructions (referred to as “in the shadow of” the predicted branch instructions, since a misprediction can cause the instructions in the shadow to be flushed). Instructions in the shadow of a predicted branch may also be referred to as “control speculative”, since misprediction of the branch instruction may cause the instructions to be cancelled. Other instructions may cause exceptions (also referred to as traps or interrupts), which typically cause redirection of instruction execution to an exception handler. Still further, speculation on some instructions may cause subsequent instructions to be flushed. For example, some processors may implement data speculation (e.g. speculating that a load will hit in the cache and forwarding the data, or scheduling dependent instructions before the cache hit is known). Instructions that use speculative operands (e.g. due to data speculation) may be referred to as “data speculative”. A given instruction may be control speculative, data speculative, or both.

While speculative execution can improve parallelism and average instruction throughput, corrective measures are required when speculation is incorrect. For example, the incorrectly executed instructions need to be eliminated from the pipeline, including any speculative results. The instructions can be refetched and provided to the processor pipeline again, and can be executed non-speculatively, or at least with the source of incorrect speculation resolved.

One mechanism that is often used to “undo” incorrect speculation is to checkpoint the speculative state. When a given instruction is founded to be misspeculated, the most recent speculative state that precedes that instruction can be restored, and if there are instructions between the most recent speculative state and the given instruction, those instructions can update the restored state to reach the state prior to the given instruction (or subsequent to the given instruction, if the given instruction is itself correctly executed). The speculative state that is to be restored for a given instruction is referred to herein as the speculative state corresponding to the instruction.

Some processors have checkpointed every instruction, to simplify recovery from misspeculation. However, the speculative state may be fairly large, and thus checkpointing the state is expensive in both processor chip area (for the checkpoint storage) and in power consumption (to read and write the state). So, other processors have implemented less frequent checkpointing. For example, other processors checkpoint every N instructions, were N is a fixed integer. The Power4 processors from IBM implement checkpointing every fourth instruction, for example. Still other processors checkpoint every branch instruction, but no other instructions. All of these mechanisms suffer from checkpointing many instructions unnecessarily, which is an inefficient use of the checkpoint resource.

### SUMMARY

In one embodiment, a processor comprises a predictor, a checkpoint unit, and circuitry coupled to the checkpoint unit. The predictor is configured to predict an event that can occur during an execution of an instruction operation in the processor. Furthermore, the predictor is configured to provide a confidence indicator corresponding to the prediction. The confidence indicator indicates a relative probability of a correctness of the prediction. The checkpoint unit is configured to store checkpoints of speculative state corresponding to respective instruction operations. Coupled to receive the confidence indicator, the circuitry is configured to save a first checkpoint of speculative state corresponding to the instruction operation if the confidence indicator indicates a first level of probability of correctness. The circuitry is further configured not to save the first checkpoint if the confidence indicator indicates a second level of probability.

In an embodiment, a method comprises predicting an event that can occur during an execution of an instruction operation in a processor; providing a confidence indicator corresponding to the prediction, wherein the confidence indicator indicates a relative probability of a correctness of the prediction; saving a first checkpoint of speculative state corresponding to the instruction operation if the confidence indicator indicates a first level of probability of correctness; and not saving the first checkpoint if the confidence indicator indicates a second level of probability.

In one embodiment, a computer system comprises a processor and a communication device. The processor is configured to predict an event that can occur during an execution of an instruction operation in the processor, and further configured to provide a confidence indicator corresponding to the prediction. The confidence indicator indicates a relative probability of a correctness of the prediction, and the processor is configured to save a first checkpoint of speculative state corresponding to the instruction operation if the confidence indicator indicates a first level of probability of correctness. Furthermore, the processor is configured not to save the first checkpoint if the confidence indicator indicates a second level of probability. The communication device is configured to communicate with another computer.

### BRIEF DESCRIPTION OF THE DRAWINGS

The following detailed description makes reference to the accompanying drawings, which are now briefly described.

FIG. 1 is a block diagram of one embodiment of a processor.

FIG. 2 is a flowchart illustrating operation of one embodiment of a processor for creating a checkpoint.

FIG. 3 is a flowchart illustrating operation of one embodiment of a processor for updating a predictor.

FIG. 4 is a block diagram of one embodiment of a computer system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

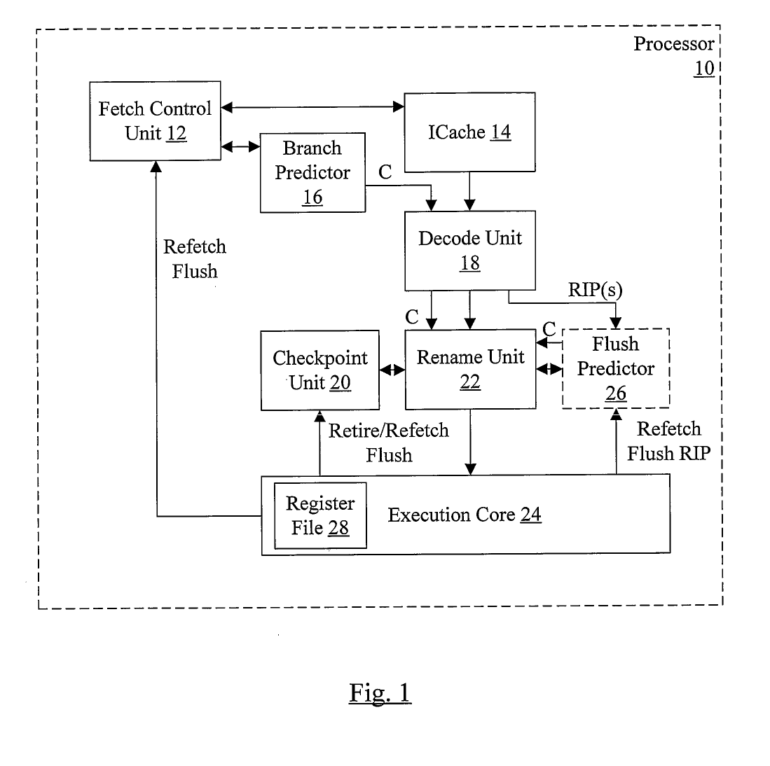

Turning now to FIG. 1, a block diagram of one embodiment of a processor 10 is shown. In the illustrated embodiment, the processor 10 comprises a fetch control unit 12, an instruction cache (ICache) 14, a branch predictor 16, a decode unit 18, a rename unit 22, an execution core 24, a checkpoint unit 20, and optionally a flush predictor 26. The fetch control unit 12 is coupled to the ICache 14, the branch predictor 16, and the execution core 24. The ICache 14 and the branch predictor 16 are further coupled to the decode unit 18, which is further coupled to the rename unit 22. The rename unit 22 is further is further coupled to the execution core 24, the checkpoint unit 20, and the flush predictor 26. The execution core 24 is further coupled to the checkpoint unit 20 an the flush predictor 26. The execution core 24 includes a register file 38.

The term operation, or instruction operation, (or more briefly “op”) will be used herein with regard to instructions executed by the processor 10. Generally, an operation may comprise any operation that execution resources within the processor 10 may execute. Operations may have a one-to-one mapping to instructions specified in an instruction set architecture that is implemented by the processor 10. The operations may be the same as the instructions, or may be in decoded form. Alternatively, instructions in a given instruction set architecture (or at least some of the instructions) may map to two or more operations. In some cases, microcoding may be implemented and the mapping may comprise a microcode routine stored in a microcode read-only memory (ROM). In other cases, hardware may generate the operations, or a combined approach of hardware generation and microcoding may be used. Thus, branch operations (or more briefly “branches”) correspond to, or are derived from, branch instructions. Branch operations may also be derived from non-branch instructions that are microcoded (e.g. the microcode routine corresponding to the non-branch, microcoded instruction may include branch operations). Load operations and store operations (or more briefly “loads” and “stores”) correspond to, or are derived from, load and store instructions or other instructions having a memory operand. Similarly, other operations may correspond to, or be derived from, other instructions.

A refetch flush event may generally refer to causing the fetch unit of a processor to discontinue its current fetch path and to begin fetching at a newly supplied fetch address (or program counter (PC) address) and flushing any operations in the pipeline that are subsequent to the operation for which the refetch flush event is performed. In one embodiment, the processor 10 may implement the AMD64™ extensions to the x86 (or IA-32) instruction set architecture, and thus the fetch address is the RIP (the 64 bit instruction pointer).

The processor 10 may implement speculative execution, and thus may have speculative state associated with each operation. The speculative state may reflect the speculative execution of that operation, and any operations the precede the operation in the speculative program order. That is, the speculative state may correspond to the architected state that would exist if an exception or other interrupt occurred for the operation. If a refetch flush event is performed with respect to the instruction operation, the speculative state of the processor is to be restored to the speculative state that corresponds to that instruction operation.

The speculative state may take any form. For example, in the illustrated embodiment, the processor 10 implements register renaming in the rename unit 22. That is, the register renamer 22 may rename the logical registers to physical registers in the register file 28. As speculative execution is performed, the mapping of logical registers to physical registers is changed so that operations may speculatively write results to the register file. Accordingly, the logical to physical register mapping may be speculative state. This register mapping will be used as an example of speculative state, but any other form may be used in other embodiments. The logical registers may include architected registers specified by the instruction set architecture implemented by the processor 10, and may also include various implementation-specific registers made available to the programmer and/or microcode temporary registers used by microcode routines. The physical registers may be the registers that form the register file 28.

The processor may include one or more predictors that predict an event that can occur during execution of a given operation. The event may result in a refetch flush event, or a misprediction of the event may result in the refetch flush event. The predictors may also provide a confidence indicator that indicates the relative probability that the prediction is correct (that is, relative to other predictions made by the predictor). Circuitry that manages speculative state, such as the rename unit 22, may selectively create a checkpoint of the speculative state that corresponds to the operation dependent on the level of probability indicated by the confidence indicator. That is, if the confidence indicator indicates a first probability level, the checkpoint may be made. If the confidence indicator indicates a second probability level, the checkpoint may not be made. Viewed in another way, a checkpoint may be made if the probability that a refetch flush event will occur is relatively high, and the checkpoint may not be made if the probability that a refetch flush event will occur is relatively low.

By checkpointing those operations having a higher probability of the refetch flush, efficient use of the checkpoint unit 20 may be made, in some embodiments. The checkpoint unit 20 may comprise storage for multiple checkpoints, and those locations may be used for checkpoints with higher probability of being restored as the speculative state in a refetch flush event. Thus, the chip area and power consumed by the checkpoint unit 20 may be more efficiently used. Viewed in another way, fewer checkpoints may be maintained to achieve a given performance level, in some embodiments.

For example, the branch predictor 16 may be one of the predictors, and predicts branches. The predicted event is the taken/not taken result of the branch, and misprediction of the event causes a refetch flush because the control speculative instructions subsequent to the mispredicted branch have been fetched from the wrong path, and the correct instructions are to be fetched. In other embodiments, the target address may also be predicted.

The branch predictor 16 may maintain a confidence mechanism for its branch predictions, and may use the confidence mechanism to generate the confidence indicator used by the rename unit 22 to determine whether or not to save a checkpoint. The confidence indicator is shown in FIG. 1 as “C” flowing from the branch predictor 16 through the decode unit 18 to the rename unit 22. For example, a two bit saturating counter is used, in some embodiments, with the most significant bit indicating taken (binary one) or not taken (binary zero). The counter is incremented each time the corresponding branch is taken, and decremented if not taken, saturating at 11 (in binary) for increments and 00 (again in binary) for decrements. The counter thus may also indicate the strength of the prediction. A counter value of 11 may indicate strongly taken; a counter value of 10 may indicate weakly taken; a counter value of 01 may indicate weakly not taken, and a counter value of 00 may indicate strongly not taken (again, all in binary). A strongly taken or not taken prediction may be more likely to be correct, in general, then a weakly taken or not taken prediction. Thus, the confidence indicator may indicate high confidence that the prediction is correct for strong counter values, and low confidence for weak counter values. While the two bit counter is one example, other examples may use any mechanism to track prediction accuracy and confidence. The branch predictor 16 may implement any branch prediction mechanism as well. In some embodiments, the confidence indicator may be the counter, and the rename unit 22 may interpret the counter to determine if the confidence in the prediction is high or low. In other embodiments, the branch predictor 16 may generate the confidence indicator to indicate levels of confidence, independent of whether the prediction is taken or not taken.

Many branches frequently have the same taken/not taken result, and thus are strongly taken or not taken. The rename unit 22 may not save checkpoints for such branches, and may thus not consume checkpoint locations on branches that are not likely to be mispredicted, and thus not likely to have a refetch flush. Not shown in FIG. 1 is the update mechanism for the branch predictor 16 when branches are mispredicted and when they are correctly predicted. Any branch predictor update mechanism may be used. For example, updates may be made when the branches are retired, and/or when a misprediction is signalled, in various embodiments.

In some embodiments, another predictor may be included to predict other instruction operations besides branches. For example, in one embodiment, the processor 10 may implement data speculation for loads. The term “data speculation” may be used herein to refer to any speculative forwarding of data as a result before the data is known to be the data that corresponds to the result (e.g. forwarding of data from a cache prior to detecting if the cache access is a hit). Data speculation may refer to scheduling operations that depend on the data, speculating that the data will be available before the operation needs the data (e.g. scheduling operations dependent on a load, presuming a cache hit). Data speculation may be implemented for loads, but may in general be implemented for any operation in which data may be generated prior to verifying that the data is the result of the operation. As mentioned previously, operations that receive speculative operands, and which may require correction if the operands are misspeculated, may be data speculative. Instruction operations may be data speculative independent of whether or not they are control speculative.

Loads may be scheduled, and dependent operations on the load may be scheduled assuming that the load hits in a data cache in the execution core 24 (not shown in FIG. 1). If a cache miss is detected, the data speculation is incorrect. Similarly, if the execution core 24 includes a store queue holding uncommitted stores, the load may read store data. If the store data cannot be forwarded (e.g. the store data isn't available yet, or the store data is only part of the data that the load reads), a store to load forward situation exists but cannot be serviced. Again, data speculation is incorrect. In some embodiments, data may be forwarded from the data cache before the hit is confirmed. If the data is a miss, the data speculation is incorrect.

The flush predictor 26 may be included in some embodiments, and may be configured to predict the refetch flush event for loads. In other embodiments, the flush predictor 26 may predict all operations (e.g. including branches) and may be the only predictor in the processor 10. Alternatively, the branch predictor may be still be used but the flush predictor 26 may predict the confidence for checkpointing purposes.

In one embodiment, the flush predictor 26 may store fetch addresses (or RIPs) of instructions and a predictor for the operation. For example, a two bit saturating counter may be used in one embodiment, similar to the branch predictor description above. However, the predictor may indicate the strength or weakness of the prediction of the refetch flush occurring for the operation. If the confidence is high, a checkpoint may be saved by the rename unit 22. If the confidence is low, a checkpoint may not be saved. Other embodiments may implement other confidence mechanisms, using more data, etc. Similar to the branch predictor 16, the flush predictor 26 may generate the confidence indicator to indicate the confidence of the refetch flush prediction, or may provide the counter as the confidence indicator.

The flush predictor 26 may have any configuration (e.g. set associative, direct mapped, etc. based on RIP) and any capacity (any number of entries). The flush predictor 26 may be indexed by the RIP(s) of operations provided to the rename unit 22, and may provide a confidence indictor to the rename unit 22. The flush predictor 26 may comprise a content addressable memory (CAM), in some embodiments, to detect an RIP hit and output a prediction or confidence indicator.

In addition to saving checkpoints based on the confidence indicators, the rename unit 22 may implement the register renaming. The rename unit 22 may maintain a mapping of logical registers to physical registers, and may rename each source logical register to a physical register based on the mapping. The rename unit 22 may also assign a free physical register to each destination register, and may rename the destination registers with the newly assigned physical registers. The rename unit 22 may update the mapping to reflect the newly assigned physical registers.

The fetch control unit 12 is configured to generate fetch addresses to fetch instructions for execution in the processor 10. The fetch control unit 12 is coupled to the branch predictor 16, and uses the branch predictions generated by the branch predictor 16 to control subsequent fetching. Additionally, refetch flush controls may be provided the by the execution core 24 for redirecting fetching when a refetch flush occurs. The refetch flush controls may include various signals and the redirect fetch address (or RIP).

The decode unit 18 comprises circuitry to decode the instruction bytes fetched from the ICache 14, providing operations to the rename unit 22. The decode unit 18 may include a microcode unit, if microcoding is implemented. For variable length instruction sets such as the AMD64 instruction set, decoding may include locating the instructions in the instruction bytes.

The rename unit 22 provides the operations and their renames to the execution core 24. The execution core 24 may include scheduling circuitry (e.g. centralized scheduler, reservation stations, etc.) to schedule operations for execution when their operands are available. The execution core 24 may represent one or more parallel execution units that execute various operations. For example, various embodiments of the execution core 24 may comprise one or more integer units, one or more address generation units (for load/store operations), one or more floating point units, and/or one or more multimedia units, a data cache, etc. The execution core 24 may also include exception detection hardware, and retirement hardware to retire instructions that are no longer speculative and have executed correctly.

The execution core 24 may indicate retirement of operations to the checkpoint unit 20. The checkpoint unit 20 may retain each checkpoint until an operation corresponding to a subsequent checkpoint is retired, at which point that previous checkpoint can be discarded. Additionally, if a refetch flush event is detected, the execution core 24 may also indicate such to the checkpoint unit 20. The checkpoint unit 20 may discard checkpoints that are after the instruction operation for which the refetch flush is detected, and may provide the most recent checkpoint prior to that instruction operation to the rename unit 22 to restore the speculative state. If instruction operations are between the restored speculative state and the instruction operation for which the refetch flush is detected, the rename unit 22 may recover the speculative state from the restored state by reprocessing the intervening instruction operations.

The execution core 24 may also provide the refetch flush RIP to the flush predictor 26. The flush predictor 26 may update the confidence mechanism to indicate more confident if a refetch flush is detected. If the refetch flush RIP is a miss in the flush predictor 26, the flush predictor 26 may allocate an entry and store the refetch flush RIP and an initial confidence level (e.g. weakly confident). The execution core 24 may further indicate the refetch flush event, and provide the refetch flush RIP, to the fetch control unit 12 to begin refetching the desired instructions.

In some embodiments, the rename unit 22 may tag an operation which was predicted by the flush predictor 26 to experience a refetch flush. If the operation does not experience the refetch flush, the execution core 24 may signal the flush predictor 26 to update to less confident for that RIP, since the prediction was incorrect. The tag may also be used to identify the corresponding checkpoints, in some embodiments.

Each of the ICache 14 and the data cache in the execution core 24 may comprise any configuration and capacity, in various embodiments. In some embodiments, the ICache 14 may also store predecode data, such as instruction start and/or end indicators to identify the locations of instructions.

In some embodiments, the processor 10 may support multithreading. For example, an embodiment may have shared instruction cache and decode hardware, but may have separate per-thread execution clusters.

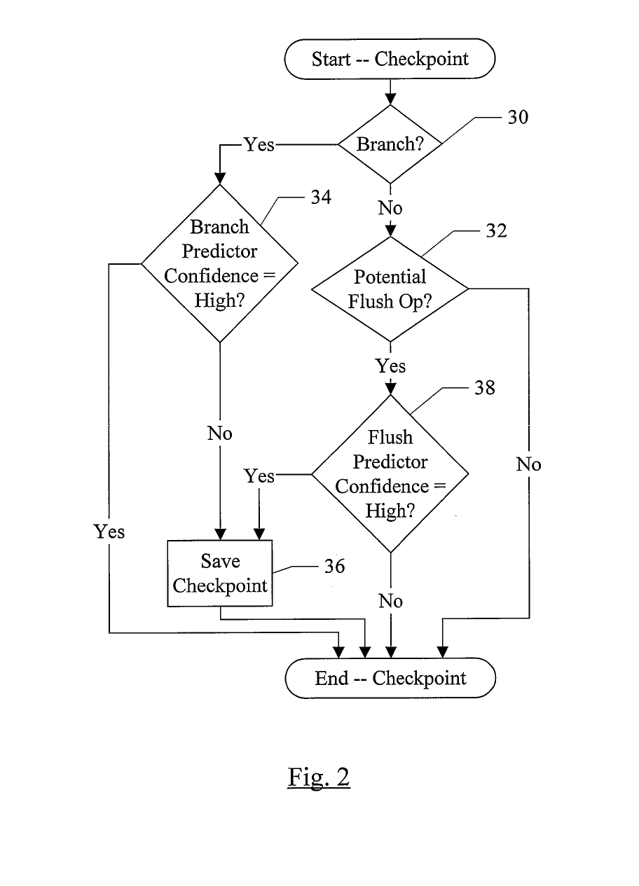

Turning now to FIG. 2, a flowchart is shown illustrating operation of one embodiment of the rename unit 22 for determining if a checkpoint is to be created. While the blocks are shown in a particular order for ease of understanding, other orders may be used. Furthermore, blocks may be performed in parallel in combinatorial logic in the rename unit 22. For example, blocks 30 and 32 are independent and may be performed in parallel. Blocks, combinations of blocks, and/or the flowchart as a whole may be pipelined over multiple clock cycles.

The rename unit 22 may perform the checkpoint decision operations in response to receiving one or more instruction operations from the decode unit 18. If the instruction operations include a branch (decision block 30, “yes” leg), the rename unit 22 may determine if the confidence of the branch predictor 16 in the branch prediction is high. For example, in the two bit counter scheme described above, the confidence may be high if the prediction is strongly taken or strongly not taken. If the confidence is high (decision block 34, “yes” leg), no checkpoint may be saved for the branch. If the confidence is low (e.g. weakly taken or weakly not taken), the likelihood of a refetch flush event due to branch misprediction may be higher, and thus the rename unit 22 may save a checkpoint to the checkpoint unit 22 for the branch (decision block 34, “no” leg, and block 36).

For non-branch instruction operations, the rename unit 22 may determine if the operation has the potential to cause a refetch flush. For example, loads may cause such operation. If so (decision block 32, “yes” leg), the rename unit 22 may receive a confidence indicator from the flush predictor 26. If the flush predictor 26 indicates high confidence in a refetch flush event (decision block 38, “yes” leg), the rename unit 22 may save a checkpoint for the instruction operation to the checkpoint unit 20 (block 36).

In other embodiments, the flush predictor 26 may predict the non-occurrence of a refetch flush event and may provide a confidence indicator of the prediction to the rename unit 22. In such embodiments, the confidence indicator may be interpreted in the same way as the confidence indicator for branches from the branch predictor 16. In still other embodiments, the flush predictor 26 may predict the occurrence of refetch flush events, but may generate the confidence indicator to have low confidence if the confidence in the prediction is high and high confidence if the confidence in the prediction is low, so again the confidence indicator may be interpreted in the same way as the confidence indicator from the branch predictor 16. In still other embodiments, the branch predictor 16 may reverse the meaning of the confidence indicator so that the confidence indicators may be interpreted in the same way.

It is noted that, in some embodiments, the flush predictor 26 may not be implemented and the rename unit 22 may use the branch predictor 16's confidence indicator to selectively checkpoint branches. In other embodiments, a single predictor (e.g. the flush predictor 26) may predict all operations that may cause a flush (branches and non-branches).

In other embodiments, the operation illustrated in FIG. 2 may be implemented in the checkpoint unit 20, or a combination of the checkpoint unit 20 and the rename unit 22. Generally, circuitry that implements the operation illustrated in FIG. 2 may be included in the processor 10.

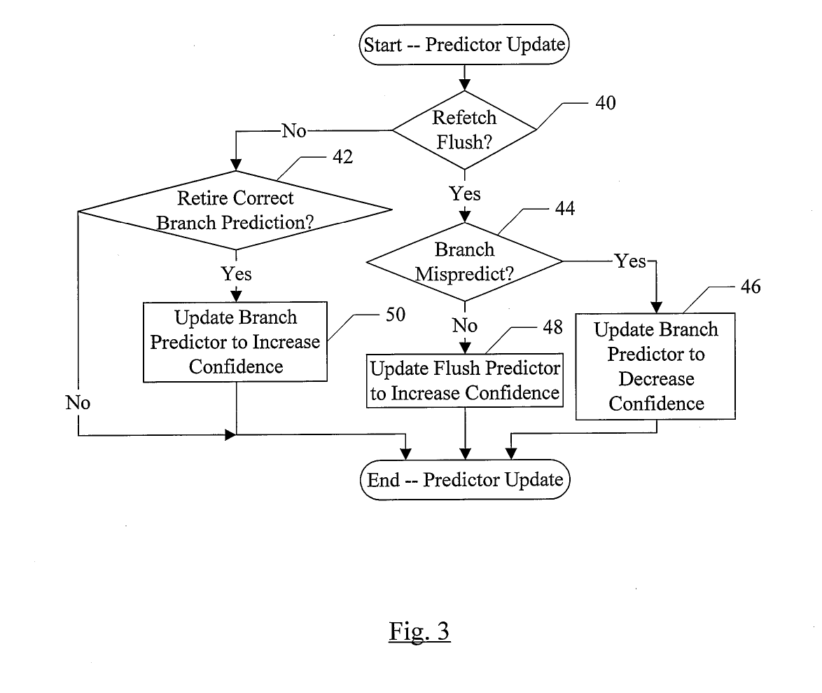

Turning now to FIG. 3, a flowchart is shown illustrating operation of one embodiment of updating predictors. While the blocks are shown in a particular order for ease of understanding, other orders may be used. For example, blocks 40 and 42 are independent and may be performed in parallel. Furthermore, blocks may be performed in parallel in combinatorial logic in the predictors. Blocks, combinations of blocks, and/or the flowchart as a whole may be pipelined over multiple clock cycles.

If a refetch flush event occurs (decision block 40, “yes” leg), and the instruction operation for which the refetch flush occurs is a branch (due to a branch misprediction—decision block 44, “yes” leg), the branch predictor 16 may update to decrease the confidence in the branch prediction (block 46). For example, if the prediction was not taken, the predictor may be modified to more weakly not taken or may be changed to weakly taken. Similarly, if the prediction was taken, the predictor may be modified to more weakly taken or may be changed to weakly not taken. In other embodiments, the branch predictor update may be delayed until the branch instruction retires. Viewed in another way, decision block 44, “yes” leg may be performed if control misspeculation is detected. If the refetch flush occurs for a non-branch instruction operation (decision block 44, “no” leg), the flush predictor 26 update the prediction to increase confidence (block 48). Updating the predictor to increase the confidence may also include allocating an entry, if no predictor entry is currently stored in the predictor for the instruction operation that had the refetch flush. Again, the update may be delayed until the instruction operation is retired, in some embodiments. Viewed in another way, decision block 44, “no” leg may be performed if data misspeculation is detected.

If a branch that was correctly predicted is retired (decision block 42, “yes” leg), the branch predictor 16 may update the prediction to increase the confidence in the prediction (block 50).

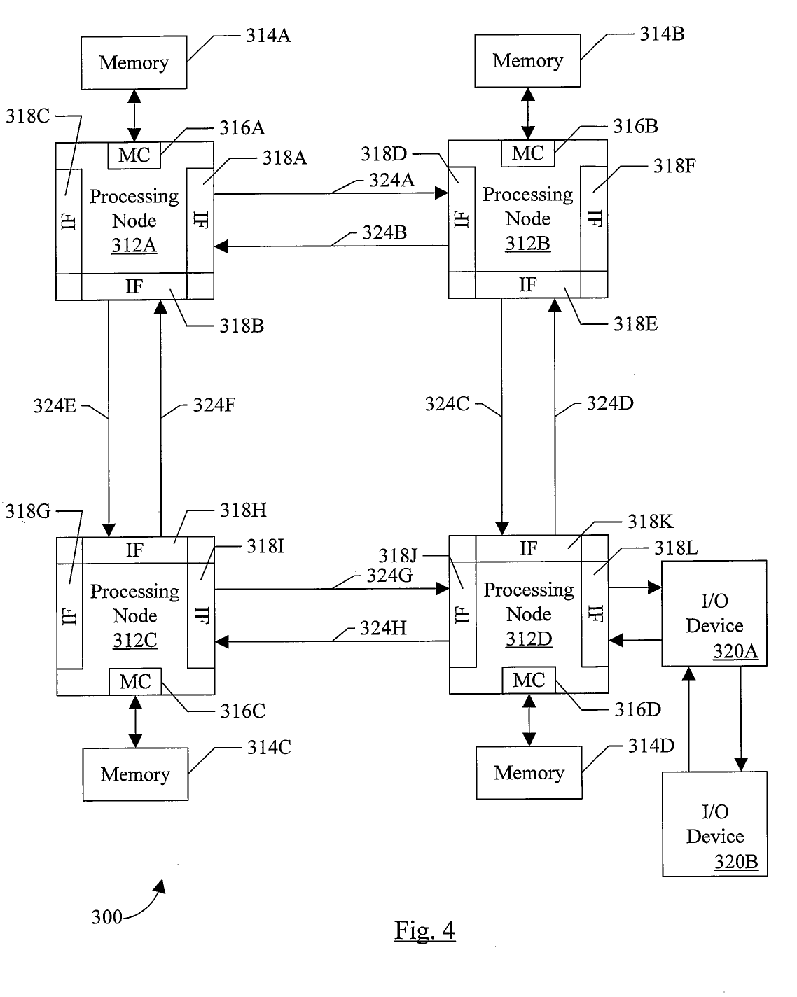

Turning now to FIG. 4, an embodiment of a computer system 300 is shown. In the embodiment of FIG. 4, computer system 300 includes several processing nodes 312A, 312B, 312C, and 312D. Each processing node is coupled to a respective memory 314A-314D via a memory controller 316A-316D included within each respective processing node 312A-312D. Additionally, processing nodes 312A-312D include interface logic used to communicate between the processing nodes 312A-312D. For example, processing node 312A includes interface logic 318A for communicating with processing node 312B, interface logic 318B for communicating with processing node 312C, and a third interface logic 318C for communicating with yet another processing node (not shown). Similarly, processing node 312B includes interface logic 318D, 318E, and 318F; processing node 312C includes interface logic 318G, 318H, and 3181; and processing node 312D includes interface logic 318J, 318K, and 318L. Processing node 312D is coupled to communicate with a plurality of input/output devices (e.g. devices 320A-320B in a daisy chain configuration) via interface logic 318L. Other processing nodes may communicate with other I/O devices in a similar fashion.

Processing nodes 312A-312D implement a packet-based link for inter-processing node communication. In the present embodiment, the link is implemented as sets of unidirectional lines (e.g. lines 324A are used to transmit packets from processing node 312A to processing node 312B and lines 324B are used to transmit packets from processing node 312B to processing node 312A). Other sets of lines 324C-324H are used to transmit packets between other processing nodes as illustrated in FIG. 4. Generally, each set of lines 324 may include one or more data lines, one or more clock lines corresponding to the data lines, and one or more control lines indicating the type of packet being conveyed. The link may be operated in a cache coherent fashion for communication between processing nodes or in a noncoherent fashion for communication between a processing node and an I/O device (or a bus bridge to an I/O bus of conventional construction such as the Peripheral Component Interconnect (PCI) bus or Industry Standard Architecture (ISA) bus). Furthermore, the link may be operated in a non-coherent fashion using a daisy-chain structure between I/O devices as shown. It is noted that a packet to be transmitted from one processing node to another may pass through one or more intermediate nodes. For example, a packet transmitted by processing node 312A to processing node 312D may pass through either processing node 312B or processing node 312C as shown in FIG. 4. Any suitable routing algorithm may be used. Other embodiments of computer system 300 may include more or fewer processing nodes then the embodiment shown in FIG. 4.

Generally, the packets may be transmitted as one or more bit times on the lines 324 between nodes. A bit time may be the rising or falling edge of the clock signal on the corresponding clock lines. The packets may include command packets for initiating transactions, probe packets for maintaining cache coherency, and response packets from responding to probes and commands.

Processing nodes 312A-312D, in addition to a memory controller and interface logic, may include one or more processors. Broadly speaking, a processing node comprises at least one processor and may optionally include a memory controller for communicating with a memory and other logic as desired. More particularly, each processing node 312A-312D may comprise one or more copies of processor 10 as shown in FIG. 1 (e.g. including various structural and operational details shown in FIGS. 2-3). One or more processors may comprise a chip multiprocessing (CMP) or chip multithreaded (CMT) integrated circuit in the processing node or forming the processing node, or the processing node may have any other desired internal structure.

Memories 314A-314D may comprise any suitable memory devices. For example, a memory 314A-314D may comprise one or more RAMBUS DRAMs (RDRAMs), synchronous DRAMs (SDRAMs), DDR SDRAM, static RAM, etc. The address space of computer system 300 is divided among memories 314A-314D. Each processing node 312A-312D may include a memory map used to determine which addresses are mapped to which memories 314A-314D, and hence to which processing node 312A-312D a memory request for a particular address should be routed. In one embodiment, the coherency point for an address within computer system 300 is the memory controller 316A-316D coupled to the memory storing bytes corresponding to the address. In other words, the memory controller 316A-316D is responsible for ensuring that each memory access to the corresponding memory 314A-314D occurs in a cache coherent fashion. Memory controllers 316A-316D may comprise control circuitry for interfacing to memories 314A-314D. Additionally, memory controllers 316A-316D may include request queues for queuing memory requests.

Generally, interface logic 318A-318L may comprise a variety of buffers for receiving packets from the link and for buffering packets to be transmitted upon the link. Computer system 300 may employ any suitable flow control mechanism for transmitting packets. For example, in one embodiment, each interface logic 318 stores a count of the number of each type of buffer within the receiver at the other end of the link to which that interface logic is connected. The interface logic does not transmit a packet unless the receiving interface logic has a free buffer to store the packet. As a receiving buffer is freed by routing a packet onward, the receiving interface logic transmits a message to the sending interface logic to indicate that the buffer has been freed. Such a mechanism may be referred to as a “coupon-based” system.

I/O devices 320A-320B may be any suitable I/O devices. For example, I/O devices 320A-320B may include devices for communicating with another computer system to which the devices may be coupled (e.g. network interface cards or modems). Furthermore, I/O devices 320A-320B may include video accelerators, audio cards, hard or floppy disk drives or drive controllers, SCSI (Small Computer Systems Interface) adapters and telephony cards, sound cards, and a variety of data acquisition cards such as GPIB or field bus interface cards. Furthermore, any I/O device implemented as a card may also be implemented as circuitry on the main circuit board of the system 300 and/or software executed on a processing node. It is noted that the term “I/O device” and the term “peripheral device” are intended to be synonymous herein.

Furthermore, one or more processors 10 may be implemented in a more traditional personal computer (PC) structure including one or more interfaces of the processors to a bridge to one or more I/O interconnects and/or memory.

Numerous variations and modifications will become apparent to those skilled in the art once the above disclosure is fully appreciated. It is intended that the following claims be interpreted to embrace all such variations and modifications.

What is claimed is:

1. A processor comprising:
a predictor configured to predict an event that can occur during an execution of an instruction operation in the processor, wherein the predictor is further configured to provide a confidence indicator corresponding to the prediction, and wherein the confidence indicator indicates a relative probability of a correctness of the prediction;
a checkpoint unit configured to store checkpoints of speculative state corresponding to respective instruction operations; and
circuitry coupled to receive the confidence indicator and configured to save a first checkpoint of speculative state corresponding to the instruction operation if the confidence indicator indicates a first level of probability of correctness, and wherein the circuitry is configured not to save the first checkpoint if the confidence indicator indicates a second level of probability.

2. The processor as recited in claim 1 wherein the circuitry comprises a rename unit configured to perform register renaming, and wherein the speculative state comprises a mapping of logical registers to physical registers in a register file.

3. The processor as recited in claim 1 wherein the predictor is a branch predictor, and wherein the instruction operation is a branch, and wherein the event comprises a taken/not taken result of the branch, and wherein the first level is weakly predicted and wherein the second level is strongly predicted.

4. The processor as recited in claim 3 further comprising a second predictor configured to predict an event corresponding to other instruction operations besides branches, and further configured to provide the confidence indicator for the prediction.

5. The processor as recited in claim 4 wherein the event is a refetch flush of instructions subsequent to the other instruction operation.

6. The processor as recited in claim 5 wherein the other instruction operations comprise a load, and where the refetch flush occurs due to an incorrect data speculation on the load.

7. The processor as recited in claim 6 wherein the incorrect data speculation is due to a failure to forward store data in store to load forward situation.

8. The processor as recited in claim 6 wherein the incorrect data speculation is due to a cache miss for the load.

9. The processor as recited in claim 1 wherein the predictor is configured to predict any instruction operation that can cause a refetch flush of instructions subsequent to that instruction operation.

10. The processor as recited in claim 9 wherein the instruction operation predicted by the predictor comprises a branch.

11. The processor as recited in claim 9 wherein the instruction operation predicted by the predictor comprises a load.

12. A method comprising:
predicting an event that can occur during an execution of an instruction operation in a processor;
providing a confidence indicator corresponding to the prediction, wherein the confidence indicator indicates a relative probability of a correctness of the prediction;
saving a first checkpoint of speculative state corresponding to the instruction operation if the confidence indicator indicates a first level of probability of correctness; and
not saving the first checkpoint if the confidence indicator indicates a second level of probability.

13. The method as recited in claim 12 wherein the speculative state comprises a mapping of logical registers to physical registers in a register file.

14. The method as recited in claim 12 wherein the instruction operation is a branch, and wherein the event comprises a taken/not taken result of the branch, and wherein the first level is weakly predicted and wherein the second level is strongly predicted.

15. The method as recited in claim 14 further comprising predicting an event corresponding to other instruction operations besides branches, and providing the confidence indicator for the prediction.

16. The method as recited in claim 15 wherein the event is a refetch flush of instructions subsequent to the other instruction operation.

17. The method as recited in claim 16 wherein the other instruction operations comprise a load, and where the refetch flush occurs due to an incorrect data speculation on the load.

18. The method as recited in claim 17 wherein the incorrect data speculation is due to a failure to forward store data in store to load forward situation.

19. The method as recited in claim 6 wherein the incorrect data speculation is due to a cache miss for the load.

20. A computer system comprising:
a processor configured to predict an event that can occur during an execution of an instruction operation in the processor, and further configured to provide a confidence indicator corresponding to the prediction, wherein the confidence indicator indicates a relative probability of a correctness of the prediction, and wherein the processor is configured to save a first checkpoint of speculative state corresponding to the instruction operation if the confidence indicator indicates a first level of probability of correctness, and wherein the processor is configured not to save the first checkpoint if the confidence indicator indicates a second level of probability; and
a communication device configured to communicate with another computer.
